(19) United States
(12) Patent Application Publication
(10) Pub. No.: US 2017/0138062 A1
(43) Pub. Date: May 18, 2017

(54) Flooring Plank Fasteners

(71) Applicant: Wellmade Floor Covering Int'l Inc., Wilsonville, OR (US)

(72) Inventors: Ming Chen, Wilsonville, OR (US); Zhu Chen, Nanjing (CN)

(21) Appl. No.: 14/997,971

(22) Filed: Jan. 18, 2016

(30) Foreign Application Priority Data
Nov. 17, 2015 (CN) 201510794065.2
Nov. 17, 2015 (CN) 201510794113.8
Nov. 17, 2015 (CN) 201520919804.1
Nov. 17, 2015 (CN) 201520919986.2

(51) Int. Cl. E04F 15/02

(52) U.S. Cl. CPC E04F 15/02044; E04F 2015/0205

(57) ABSTRACT

A floor fastener is described, including a main body configured to be removably attached to a surface. The floor fastener also includes one or more circlips, each of the one or more circlips fixed to the main body, each of the one or more circlips including a raised surface extending outward from the circlip and configured to removably attach to a flooring plank.

### FIELD OF THE INVENTION

The present invention relates to field assembly tools, especially those involving floor fasteners.

### CROSS-REFERENCES TO PRIORITY AND RELATED APPLICATIONS

This application claims priority from one or more of the following:

Chinese Patent Appl. No. 201510794065.2, filed Nov. 17, 2015 and entitled “Flooring with Fastener”;

Chinese Patent Appl. No. 201510794113.8, filed Nov. 17, 2015 and entitled “Flooring with Fastener”;

Chinese Patent Appl. No. 201520919804.1, filed Nov. 17, 2015 and entitled “Flooring with Fastener”; and

Chinese Patent Appl. No. 201520919986.2, filed Nov. 17, 2015 and entitled “Flooring with Fastener”.

The entire disclosures of the application recited above are hereby incorporated by reference, as if set forth in full in this document, for all purposes.

### BACKGROUND

A typical flooring installation will use planks that have “tongue and groove” edges or “click lock” edges. With tongue and groove edges, two adjacent flooring planks fit together with the tongue of one plank fitting into the groove of the other plank. The two planks are kept together by glue, nails, or other fasteners. For click lock edges, one flooring plank will snap into the grove of another flooring plank and fastening devices such as glue or nails are not needed to keep the planks together. In any case, those two methods fix the flooring to the floor beams underneath horizontally. With both tongue and groove and click lock installation systems, planks that are being fastened must be translated horizontally and installation of a given floor requires that all the planks be aligned in one orientation or else require a complicated and inconvenient installation. With such floors, if additional flooring is added or maintenance is needed below the floor (such as to service underlying pipes), or if some of the floor needs to be uninstalled for some other reason, this typically requires that the entire floor be uninstalled. Uninstalling the entire floor to perform maintenance can be both time-consuming and expensive. Accordingly, improved techniques for fastening flooring materials together and to a surface are desired.

### SUMMARY

Floor fasteners are described herein that improve upon the known shortcomings in previous floor fasteners. As described herein, a floor fastener may fasten different pieces of a floor, such as wood or faux-wood pieces of a floor, together and/or to the surface that the floor will be places over. The floor fasteners described herein may include a main body and circlips extending from that body. The circlips may have ridges on their interior and/or their exterior. The floor fasteners may be configured to be removably attached to a wall or floor, such as by screwing the fasteners in place. In order to facilitate this, the floor fasteners may have one or more screw holes, which can allow the fasteners to be attached (using screws, nails, or another means) to a surface such as a floor or a wall. Flooring may be removably attached to the floor fasteners, and the shape of the circlips can hold the flooring in place.

The following detailed description, together with the accompanying drawings, will provide a better understanding of the nature and advantages of the present invention.

### BRIEF DESCRIPTION OF THE DRAWINGS

FIG. 1 is an exemplary illustration of a floor fastener according to some aspects of the present disclosure.

FIG. 2 is another exemplary illustration of a floor fastener according to some aspects of the present disclosure, this from a top-down view.

FIG. 3 is another exemplary illustration of a floor fastener according to some aspects of the present disclosure from a cross-section view.

FIG. 4 is an exemplary illustration of an alternative floor fastener design according to some aspects of the present disclosure from a cross-section view.

FIG. 5 is another exemplary illustration of an alternative floor fastener design according to some aspects of the present disclosure from a cross-section view.

FIG. 6 is another exemplary illustration of an alternative floor fastener design according to some aspects of the present disclosure from a cross-section view.

FIG. 7 is an exemplary illustration of flooring which has been installed using flooring fasteners according to some aspects of the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

The present description provides detail for the invention in conjunction with the appended figures and specific implementation approaches. A floor fastener that overcomes the shortcomings of the exiting technology is described herein. This floor fastener may allow for more convenient installation, such as the ability to install flooring vertically, and to perform maintenance on areas underneath the flooring material more easily.

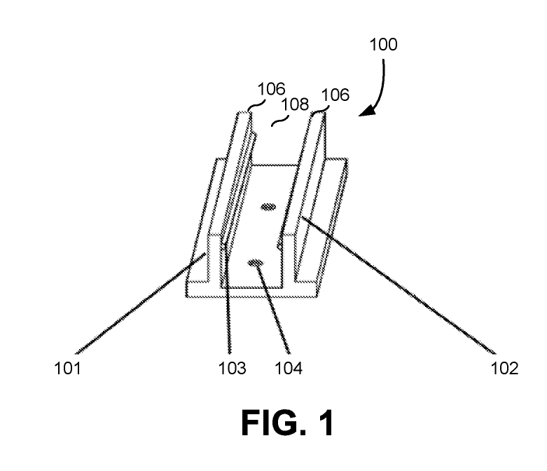

FIG. 1 is an exemplary illustration of a floor fastener 100 according to some aspects of the present disclosure. A floor fastener might be longer than that shown in FIG. 1, so FIG. 1 should be understood as possibly being only a small section of a longer floor fastener strip. As shown, floor fastener 100 includes a main body 101 that would abut a mounting surface (such as a subfloor or wall) and a circlip 102 portion that holds flooring materials, such as engineered planks, wood planks or other flooring material. Circlip 102 is shown comprising two sidewalls 106, with each sidewall 106 having a raised portion 103. Circlips might be formed of a spring material that allows for compression of other elements when a circlip is in place. Circlips need not be circular in arrangement.

The two sidewalls 106 and a portion of main body 101 form a cavity 108. The circlip 102 can be constructed from elastic, hard material. Main body 101 might also have one or more holes 104, usable to affix floor fastener 100 to a subfloor, wall, etc. using screws, nails, or other attachment means. The shape of the circlip 102 and the raised portion 103 may be designed to allow for flooring to be removably attached to floor fastener 100 in a manner that allows for selective removal (as opposed to requiring that an entire contiguous floor be replaced. For example, raised portion 103 may allow flooring to be slid or snapped into position on floor fastener 100, and floor fastener 100 itself may be fixed to a surface using one or more of holes 104. Thus, floor fastener 100 may be mounted to a surface, such as a subfloor or a wall, and flooring planks may be removably attached to floor fastener 100, such as by sliding the flooring planks into place or by snapping the flooring planks into place.

As described herein, circlips 102 and raised portions 103 may take a number of different shapes. Generally, circlips 102 may be configured to hold a flooring plank at the edge of the plank, such that the plank may be connected to a circlip at each of two edges of the plank, such as the longest two edges of the flooring plank. Circlips 102 may also be configured to connect to a single plank, such as by having circlips 102 that connect to the center of a flooring plank. Other configurations and connections between flooring planks and floor fasteners 100 may also be possible, such as attaching one or more floor fasteners 100 to each plank in other manners.

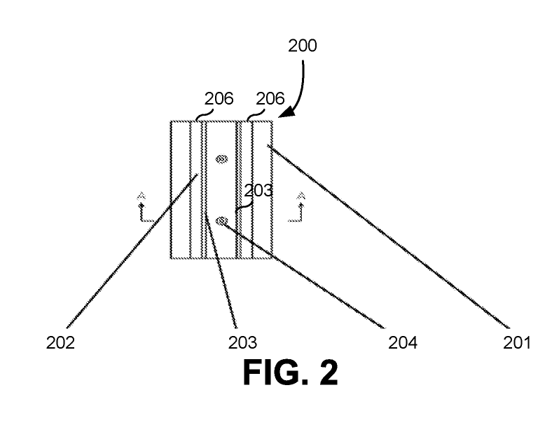

FIG. 2 is an exemplary illustration of a floor fastener 200 according to some aspects of the present disclosure. Floor fastener 200 may be similar to floor fastener 100, but is illustrated from another angle for clarity. In this example, the view would be directly facing the surface to which floor fastener 200 is to be mounted. As shown, floor fastener 200 also includes one or more holes 204, raised portions 203 on an interior of a circlip 202 attached to a main body 201. As illustrated here, circlip 202 might comprise two sidewalls 206 protruding from main body 201 of floor fastener 200, which may extend the length of floor fastener 200. Sidewalls 206, one on each side of main body 201, may run parallel to one another. Circlip 202 may be configured to be removably attached to one or more flooring plank and/or to secure a flooring plank to floor fastener 200. Floor fastener 200 itself may be secured to a surface using holes 204. Floor fastener 200 is shown including two holes 204, which may be used to screw, nail, or otherwise secure floor fastener 200 to a floor, wall, or another surface. In some aspects, the dimensions of floor fastener 200 may be different than illustrated. For example, floor fastener 200 may be longer or shorter than illustrated, and may include more or fewer holes 204, as desired.

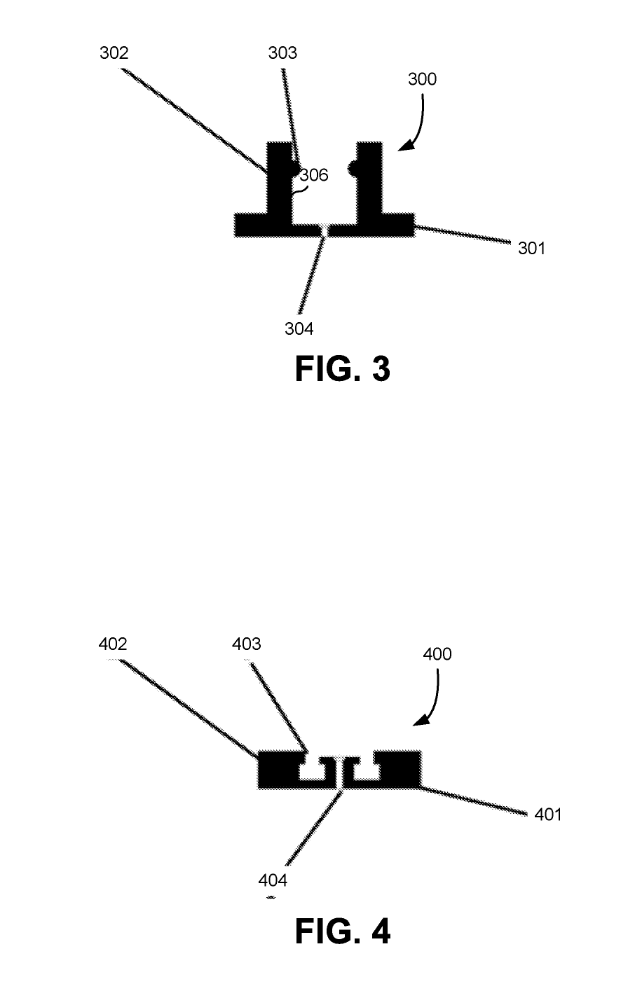

FIG. 3 is an exemplary illustration of a floor fastener 300 according to some aspects of the present disclosure. Floor fastener 300 may be similar to floor fastener 100, but is illustrated from another angle for clarity. In this example, the view is a cross section of the length of the floor fastener. This floor fastener 300 includes a main body 301 that would abut a mounting surface (such as a subfloor or wall; not shown) and a circlip 302 portion that holds flooring materials, such as engineered planks, wood planks or other flooring material. Circlip 302 is shown comprising two sidewalls 306, with each sidewall 306 having a raised portion 303. This illustration shows that the raised portion 303 of the circlip 302 is on the inside of the circlip 302. The raised portion 303 may run the length of the circlip 302, and may be used to removably attach a flooring plank to the circlip 302. Alternatively, raised portion 303 might not be continuous over the entire length of the circlip/floor fastener.

FIG. 4 is an exemplary illustration of a floor fastener 400 according to some aspects of the present disclosure. In this floor fastener 400, a circlip 402 may be shaped like a T-groove. This floor fastener 400 also includes one or more holes 404, two raised portions 403 on the interior of walls of circlip 402. Circlip 402 is attached to a main body 401. As illustrated in FIG. 4, circlip 402 may be shaped like a groove. A flooring plank may include a portion that may slide or snap into the space created by circlip 402 and one of raised portions 403. Accordingly, a flooring plank may be removably connected to floor fastener 400 by taking advantage of the shape of circlip 402 and raised portion 403.

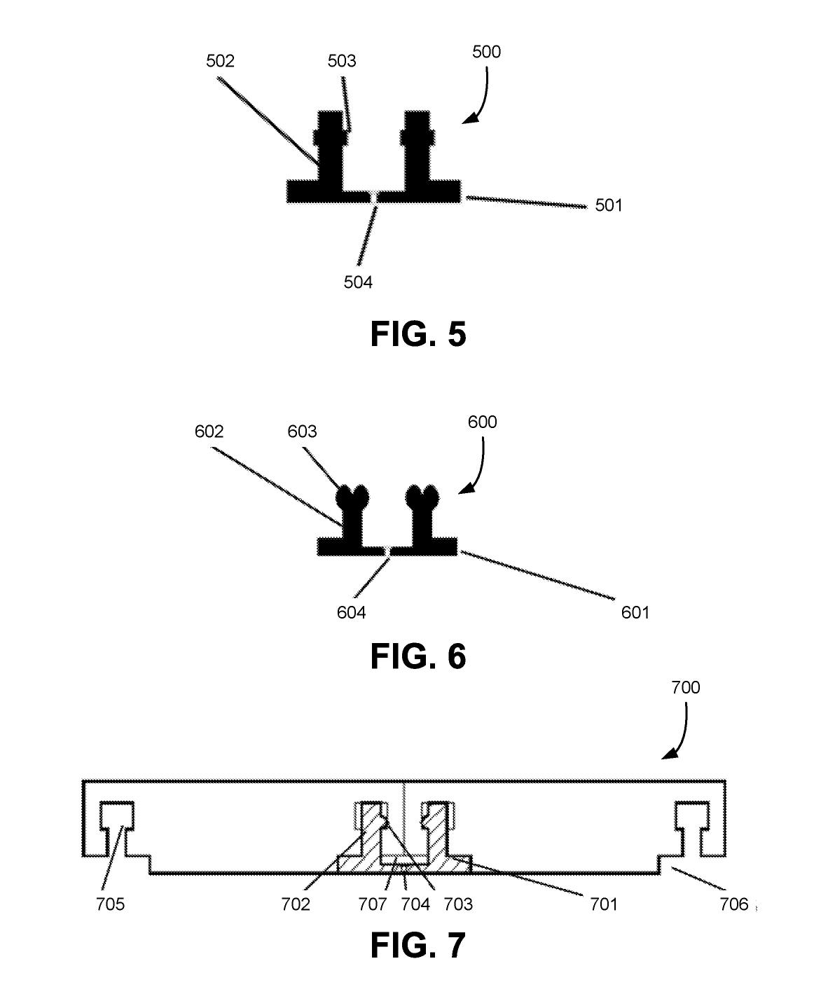

FIG. 5 is an exemplary illustration of a floor fastener 500 according to some aspects of the present disclosure. In this floor fastener 500, a circlip 502 may be shaped like a T-model. This floor fastener 500 also includes one or more holes 504, raised portions 503 on the interior and exterior of the sidewalls of circlip 502. Circlip 502 is attached to a main body 501.

FIG. 6 is an exemplary illustration of a floor fastener 600 according to some aspects of the present disclosure. In this floor fastener 600, a circlip 602 may be shaped like a Y-model. This floor fastener 600 also includes one or more holes 604, raised portions 603 on the interior and exterior of sidewalls of circlip 602, here shaped like a “Y”. Circlip 602 is attached to a main body 601. As with the other floor fasteners described herein, flooring planks may be removably attached to floor fastener 600 using the shape of circlips 602 and raised portions 603.

FIG. 7 is an exemplary illustration of a floor fastener 700 of a cross section of flooring that has been installed using flooring fasteners according to some aspects of the present disclosure. Here, floor fastener 700 is shown with a main body 701 that has been fixed to the ground or to a wall using a screw hole 704. As illustrated, a piece of flooring may include a buckle 705 configured to have a circlip 702 inserted into it. Raised portions 703 of sidewalls of circlip 702 may be configured to form a lock with a groove in buckle 705. The size of a floor gap 706 on the flooring may be designed to ensure that the bottom of main body 701 and the backside of the floor are in alignment with one another. This ensures that the backside of the floor is fitted against the surface that the flooring is mounted on, such as the ground or a wall, and that the floor, ground, and wall can form a complete bearing surface in order to reduce or minimize pressure on the fasteners and that there is a cavity 707 between the flooring and main body 701. Ideally, it is desired that there might be little or no pressure on the fasteners themselves, such that the surface underneath the flooring instead bears the pressure of weight on top of the floor.

As illustrated, each plank of flooring may be attached to at least two floor fasteners, and each floor fastener may be attached to two pieces of flooring. Each floor fastener may run the length, or a substantial portion of the length, of a flooring plank. Alternatively, each floor fastener may be short in length, such as running only a short portion of the length of the flooring planks. In some aspects, shorter floor fasteners may be used, such as being placed near the corners of each flooring plank, or near the center (length-wise) of each flooring plank. Alternative placements of floor fasteners may also be used.

In some aspects, in order to reduce the pressure on the fastener, there may be a gap between the top of circlip 702 and the flooring surface above it. This may ensure that as little weight as possible is placed onto the circlip itself, and reduce pressure on the fastener.

As illustrated, main body 701 of floor fastener 700, portions of circlip 702, and the flooring may form cavity 707. This cavity 707 may be used for electrical wiring, water, or other pipeline installation, and may be protected from the weight that is placed on the floor. In some aspects, cavity 707 may be removed by raising main body 701, which may allow for more even weight distribution. Circlip 702 may be made from an elastic, hard material.

When applying this novel fastener to install or remove the floor, the floor only needs to be vertically locked into the buckle or vertically removed from the fastener. There is no need to leave room for sliding the planks horizontally into place, such as sliding a tongue into a groove or rotating a plank to click it into place, which might not be possible at the edge of a room or where only part of a floor is being repaired. This will allow for localized floor plank replacement, convenient installation, and maintenance.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

The specification and drawings are to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. A floor fastener comprising:
a main body configured to be removably mounted to a surface; and
one or more circlips, each of the one or more circlips fixed to and extending from the main body, each of the one or more circlips including a raised surface extending outward from the circlip, the raised surface configured to removably attach to a flooring plank.

2. The floor fastener of claim 1, wherein the main body and the one or more circlips are configured to form a cavity.

3. The floor fastener of claim 1, wherein the circlip is constructed using elastic, hard materials.

4. The floor fastener of claim 1, wherein the main body includes one or more screw holes configured to allow the main body to be removably mounted to the surface.

5. The floor fastener of claim 1, wherein the main body includes a cavity between the main body and a flooring plank removably attached to the raised surface, the cavity configured to minimize pressure on the main body and on the one or more circlips, and to allow the surface to bear a pressure of weight from the flooring plank removably attached to the raised surface.
